(19) United States
(12) Patent Application Publication
(10) Pub. No.: US 2025/0124476 A1
(43) Pub. Date: Apr. 17, 2025

(54) Context-Based Generation of Summarized Reviews Using a Large Language Model

(71) Applicant: Maplebear Inc., San Francisco, CA (US)

(72) Inventor: Viswa Mani Kiran Peddinti, San Francisco, CA (US)

(21) Appl. No.: 18/485,809

(22) Filed: Oct. 12, 2023

(51) Int. Cl. G06Q 30/0282

(52) U.S. Cl. CPC G06Q 30/0282

(57) ABSTRACT

An online system receives user reviews for items and generates a review embedding for each review. The system receives a request for information describing an item from a client device associated with a user. Responsive to the request, the system identifies the item and contextual information associated with a current session of the user, and generates a user embedding based on the contextual information. The system compares the user embedding to a set of review embeddings for the item, identifies a set of reviews for the item based on the comparison, and generates a prompt including the identified set of reviews and a request to summarize, for the user, the identified set of reviews. The system provides the prompt to a large language model to obtain a summarized review for the item and sends a user interface including the item and summarized review for display to the client device.

### BACKGROUND

Online systems, such as online concierge systems, may allow users to provide reviews for items included among inventories of retailers associated with the online systems, which other users may find helpful when making decisions associated with the items. For example, an online system may allow its users to provide reviews for items, such as products or services that may be ordered from the online system. In this example, each review may include a rating for an item (e.g., one to five stars) and other information provided by a user (e.g., text, images, or videos) explaining why the user provided the rating (e.g., features about the item that the user liked or disliked, whether the user would recommend the item, etc.), which may help other users compare or filter items, identify items that best suit their needs, etc. Since a single item may have many reviews, online systems may use various techniques to help users find reviews that are likely to be relevant to them. For example, online systems may organize reviews into categories based on keywords included in the reviews, provide search functions allowing users to search reviews for certain words or phrases, or retrieve reviews based on user-specific information, such as user preferences or interactions with the online systems.

However, users may still find it difficult or time-consuming to search for relevant reviews. For example, if a user is interested in the lifespan of an item and reviews for the item are organized by category, the categories may not be very helpful if several of them (e.g., a “great value” category, a “great quality” category, etc.) seem likely to include reviews that mention this information. As an additional example, when trying to determine whether an item (e.g., laundry detergent) is appropriate for sensitive skin, a user may have to search reviews for the item for variants of words or phrases (e.g., “sensitive skin,” “fragrance-free,” etc.) and may not find relevant reviews if they leave out certain variants (e.g., “hypoallergenic,” “allergen-free,” etc.) from their search. As yet another example, an online system that retrieves reviews that are most likely to be relevant to users may face latency and scalability issues, especially if numerous reviews are available and a considerable amount of processing is involved, which may negatively impact user experience. Furthermore, in this example, if the retrieved reviews are too lengthy to be displayed in their entirety, the users may find it difficult or time-consuming to read the reviews.

### SUMMARY

In accordance with one or more aspects of the disclosure, an online system uses a large language model (LLM) to generate summarized reviews for items based on contextual information associated with users of the online system. More specifically, an online system receives reviews for items included among one or more inventories of one or more retailers associated with the online system, in which each review is associated with an item. The online system then generates a review embedding for each review for each item based on the review for the item. The online system receives a request for information describing a set of items from a client device associated with a user. Responsive to the request, the online system identifies the set of items and a set of contextual information associated with a current session of the user with the online system and generates a user embedding for the user based on user data associated with the user and the set of contextual information. The online system compares the user embedding to a set of review embeddings for each item included among the set of items and identifies a set of reviews for each item included among the set of items based on the comparison. The online system generates a prompt for a summarized review for each item included among the set of items and provides the prompt to a large language model to obtain the summarized review for each item, in which the prompt includes the identified set of reviews for each item included among the set of items and a request to summarize, for the user, the set of reviews for each item. The online system then sends a user interface for display to the client device associated with the user, in which the user interface includes the set of items and the summarized review for each item included among the set of items.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for generating summarized reviews for items using a large language model based on contextual information associated with a user of an online system, in accordance with one or more embodiments.

FIG. 4 is a process flow diagram for generating summarized reviews for items using a large language model based on contextual information associated with a user of an online system, in accordance with one or more embodiments.

FIGS. 5A and 5B illustrate examples of summarized reviews for an item based on contextual information associated with a user of an online system, in accordance with one or more embodiments.

### DETAILED DESCRIPTION

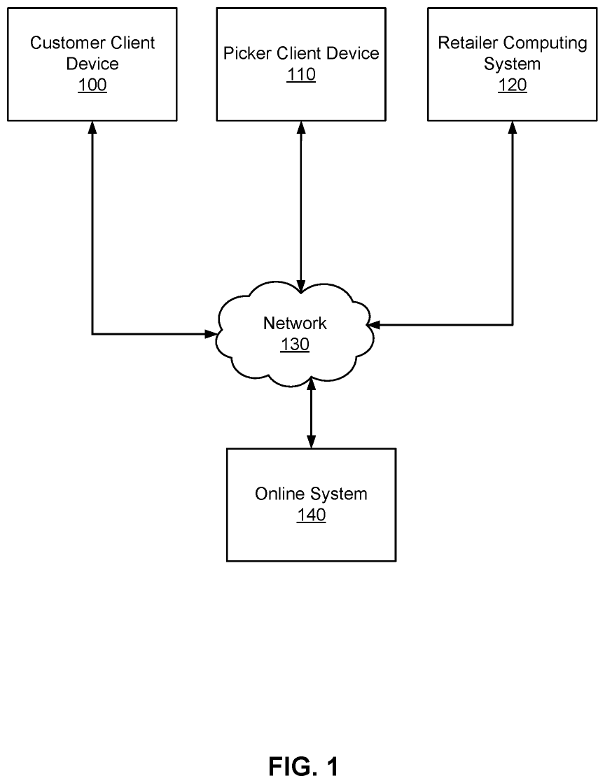

FIG. 1 illustrates an example system environment for an online system 140, such as an online concierge system, in accordance with one or more embodiments. The system environment illustrated in FIG. 1 includes a customer client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, retailers, or any other individuals or entities utilizing the online system 140 may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or a desktop computer. The customer client device 100 also may be an augmented reality device, a mixed reality device, a shopping cart system (e.g., a smart shopping cart), or any other suitable type of device. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item,” as used herein, refers to a good or product that may be provided to the customer through the online system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 may provide item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a customer's order (e.g., as a commission).

The customer client device 100, the picker client device 110, the retailer computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

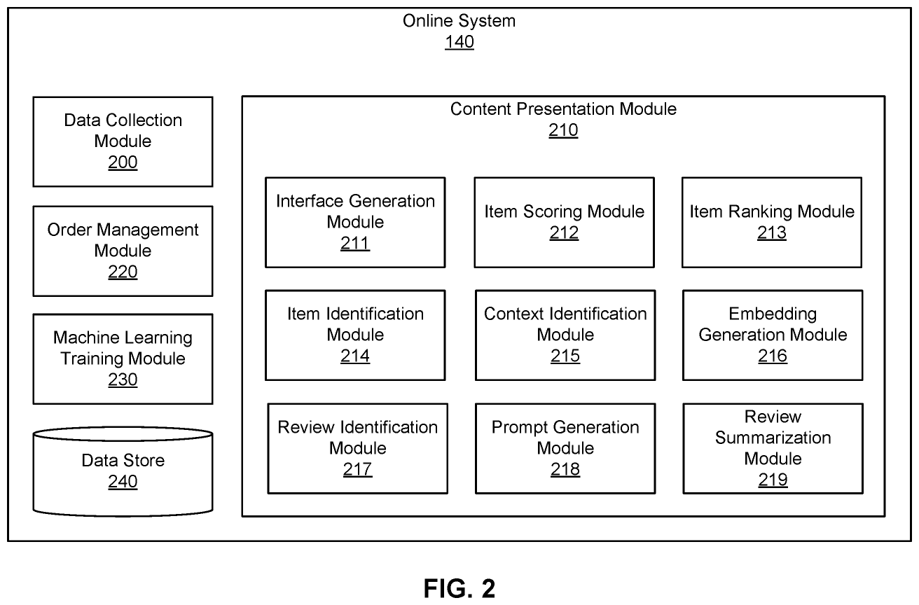

The online system 140 may be an online concierge system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer. As an example, the online system 140 may allow a customer to order groceries from a grocery store retailer. The customer's order may specify which groceries they want delivered from the grocery store and the quantities of each of the groceries. The customer client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

FIG. 2 illustrates an example system architecture for an online system 140, such as an online concierge system, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects customer data, which is information or data describing characteristics of a customer. Customer data may include a customer's name, address, stored payment instruments, preferences/restrictions, or interests. For example, customer data may include a customer's dietary preferences/restrictions (e.g., for organic and environmentally-friendly items), shopping preferences (e.g., to purchase certain types of items in bulk), hobbies, favorite items, favorite retailers, etc. Customer data also may include demographic information associated with a customer (e.g., age, gender, geographical region, etc.) or household information associated with the customer (e.g., a number of people in the customer's household, whether the customer's household includes children or pets, etc.). The customer data also may include default settings established by a customer, such as a default retailer/retailer location, payment instrument, delivery location, or delivery timeframe. Customer data further may include historical information associated with a customer. For example, customer data may describe previous orders placed by a customer with the online system 140, previous purchases made by the customer at retailer locations, or previous interactions by the customer with items or other objects (e.g., coupons, recipes, advertisements, applications, locations, businesses, etc.) within the online system 140. In this example, the previous interactions may include descriptions of the items or objects (e.g., item or object types), the types of interactions (e.g., adding items to a shopping list, searching for items, clicking on an advertisement, etc.), and the times of the interactions (e.g., a timestamp associated with each interaction). In various embodiments, customer data also includes information that is derived from other customer data. For example, based on historical order information associated with a customer, customer data may include a frequency with which the customer orders an item. The data collection module 200 may collect the customer data from sensors on the customer client device 100 or based on a customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties, or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. Item data also may include reviews for items provided by customers or other users, as further described below. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, different types of items that are on sale may be included in a “great value” item category. Furthermore, in various embodiments, an item may be included in multiple categories. For example, organic strawberries may be included in an “organic strawberries” item category, a “strawberries” item category, an “organic fruit” item category, or a “great value” item category. The item categories may be human-generated and human-populated with items. The item categories also may be generated automatically by the online system 140 (e.g., using a clustering algorithm).

As described above, user reviews, or “reviews,” for items may be received from customer client devices 100 associated with customers. In some embodiments, reviews for items may be received from devices or computing systems associated with users other than customers utilizing the online system 140, such as pickers, retailers or other individuals, entities, etc. Each review for an item may include various components, such as a title of the review, information identifying a user who provided the review, a date that the user provided the review, a rating for the item (e.g., one to five stars) and additional information (e.g., text, images, or videos) describing a reason for the rating (e.g., features about the item that the user liked or disliked, whether the user would recommend the item, etc.). Additionally, each review for an item may be stored in the data store 240 in association with item data (e.g., an item identifier) for the item. A review for an item may be summarized based on a set of contextual information associated with a user to whom the review is presented, as further described below. Furthermore, a review for an item or a summary of the review may be presented in association with additional types of information associated with the item, such as a name of the item, a description of the item, a price of the item, one or more images or videos of the item, one or more ingredients/materials included in the item, an average rating for the item, etc.

In some embodiments, the data collection module 200 also collects object data for objects other than items, such as coupons, recipes, advertisements, applications (e.g., gaming applications), locations (e.g., tourist locations), businesses (e.g., restaurants), or any other suitable types of objects. The object data may be analogous to that described above with respect to item data. For example, the data collection module 200 may collect object data including object identifiers for objects, attributes of objects (e.g., such as their sizes, prices, object categories, qualities, versions/varieties, etc.), or reviews for objects provided by customers or other users. The data collection module 200 may collect object data from a retailer computing system 120, a picker client device 110, a customer client device 100, a third-party system, or any other suitable source.

The data collection module 200 also collects picker data, which is information or data describing characteristics of pickers. For example, the data collection module 200 may collect picker data for a picker including the picker's name, the picker's location, how often the picker has serviced orders for the online system 140, a customer rating for the picker, the retailers from which the picker has collected items, or the picker's previous shopping history. Additionally, the data collection module 200 may collect picker data including preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

In some embodiments, the data collection module 200 also collects user data for users other than customers or pickers, such as retailers or other individuals, entities, etc. utilizing the online system 140. The user data may be analogous to that described above with respect to customer data or picker data. For example, the data collection module 200 may collect user data including a user's name, address/location, preferences/restrictions, or interests, as well as demographic or historical information associated with the user, information that is derived from other user data, etc. The data collection module 200 may collect the user data from a device (e.g., a client device) or a computing system that a user uses to interact with the online system 140, or based on the user's interactions with the online system 140.

Additionally, the data collection module 200 collects order data, which is information or data describing characteristics of an order. For example, the data collection module 200 may collect order data including item data for items that are included in the order, a delivery location for the order, a customer associated with the order, a retailer location from which the customer wants the ordered items collected, or a timeframe within which the customer wants the order delivered. Order data collected by the data collection module 200 may further include information describing how the order was serviced, such as which picker serviced the order, when the order was delivered, or a rating that the customer gave the delivery of the order.

The data collection module 200 also collects session data, which is information or data describing characteristics of a session of a user with the online system 140. Session data collected by the data collection module 200 may identify a session (e.g., via a session ID) and a user (e.g., via a username or other unique identifier) and describe a device (e.g., a customer client device 100 or a picker client device 110) or a computing system (e.g., a retailer computing system 120) used to communicate with the online system 140, as well as a timeframe associated with the session. Session data collected by the data collection module 200 also may include information describing a user's interactions with the online system 140, such as information describing items or objects with which the user interacted (e.g., item data for the items or object data for the objects), information describing types of the interactions (e.g., browsing, selecting, or searching for items, adding items to a shopping list, etc.), times of the interactions, dwell time, etc. For example, session data for a session of a customer may describe a request for information describing a set of items received from a customer client device 100 associated with the customer in the form of a set of search results, a set of browsing results, a set of advertisements, etc. The data collection module 200 may collect session data from a picker client device 110, a customer client device 100, a retailer computing system 120, or any other suitable device or computing system.

The content presentation module 210 selects content for presentation to a customer. For example, the content presentation module 210 selects which items to present to a customer while the customer is placing an order. Components of the content presentation module 210 include: an interface generation module 211, an item scoring module 212, an item ranking module 213, an item identification module 214, a context identification module 215, an embedding generation module 216, a review identification module 217, a prompt generation module 218, and a review summarization module 219, which are further described below. Although the functionalities of the components are described below with respect to items, in some embodiments, the components perform the functionalities with respect to objects other than items, such as coupons, recipes, advertisements, applications, locations, businesses, or any other suitable types of objects. Furthermore, while the functionalities of the components are described below with respect to customers, in some embodiments, the components perform the functionalities with respect to users of the online system 140 other than customers, such as pickers, retailers, or any other individuals or entities utilizing the online system 140.

The interface generation module 211 generates and transmits an ordering interface for a customer to order items. The interface generation module 211 populates the ordering interface with items that the customer may select for adding to their order. In some embodiments, the interface generation module 211 presents a catalog of all items that are available to the customer, which the customer can browse to select items to order. Other components of the content presentation module 210 may identify items that the customer is most likely to order and the interface generation module 211 may then present those items to the customer. For example, the item scoring module 212 may score items and the item ranking module 213 may rank the items based on their scores. In this example, the item identification module 214 may identify items with scores that exceed some threshold (e.g., the top n items or the p percentile of items) and the interface generation module 211 then displays the identified items. The interface generation module 211 also may receive a request from a customer client device 100 for information describing a set of items to be presented via one or more surfaces (e.g., a set of search results, a set of browsing results, a set of advertisements, etc.), as further described below. The interface generation module 211 subsequently may transmit a textual output of a large language model to the customer client device 100 (e.g., in a user interface), in which the textual output includes a summarized review for each of the set of items, as also further described below.

The item scoring module 212 may use an item selection model to score items for presentation to a customer. An item selection model is a machine learning model that is trained to score items for a customer based on item data for the items and customer data for the customer. For example, the item selection model may be trained to determine a likelihood that the customer will order an item. In some embodiments, the item selection model uses item embeddings describing items and customer embeddings describing customers to score items. These item embeddings and customer embeddings may be generated by separate machine learning models and may be stored in the data store 240.

In some embodiments, the item scoring module 212 scores items based on a search query received from the customer client device 100. A search query is text for a word or set of words that indicate items of interest to the customer. The item scoring module 212 scores items based on a relatedness of the items to the search query. For example, the item scoring module 212 may apply natural language processing (NLP) techniques to the text in the search query to generate a search query representation (e.g., an embedding) that represents characteristics of the search query. The item scoring module 212 may use the search query representation to score candidate items for presentation to a customer (e.g., by comparing a search query embedding to an item embedding).

In some embodiments, the item scoring module 212 scores items based on a predicted availability of an item. The item scoring module 212 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The item scoring module 212 may weight the score for an item based on the predicted availability of the item. Alternatively, items may be filtered out from presentation to a customer based on whether the predicted availability of the item exceeds a threshold.

The context identification module 215 identifies a set of contextual information associated with a customer. A set of contextual information associated with a customer may describe a context in which a set of summarized reviews for a set of items may be presented to the customer. For example, a set of contextual information associated with a customer may describe one or more surfaces (e.g., a set of search results, a set of browsing results, a set of advertisements, etc.) for presenting a set of summarized reviews for a set of items. The context identification module 215 may identify a set of contextual information associated with a customer based on a set of session data describing a current session of the customer (e.g., a request for information describing a set of items received from a customer client device 100 associated with the customer, a set of items included in a shopping list associated with the customer, etc.). In the above example, the surface(s) may be indicated by a request received by the online system 140 from a customer client device 100 associated with the customer (e.g., whether the customer has requested information describing the set of items in the context of a set of search results, a set of browsing results, a set of advertisements, etc.).

To illustrate an example of how the context identification module 215 may identify a set of contextual information associated with a customer, suppose that a search query is received from a customer client device 100 associated with a customer. In this example, a set of contextual information associated with the customer identified by the context identification module 215 may include a surface corresponding to a set of search results for presenting a summarized review for each of a set of items included among the set of search results. In the above example, suppose also that the search query is for cheese and that items included in a shopping list associated with the customer include basil, ciabatta bread, and tomatoes. In this example, the set of contextual information associated with the customer may indicate that the summarized review for each item may describe cheeses that go well with basil, ciabatta bread, and tomatoes. As an additional example, suppose that a request to browse items included in a “great value” item category is received from a customer client device 100 associated with a customer. In this example, the set of contextual information associated with the customer may include a surface corresponding to a set of browsing results for a set of items that are on sale and an additional surface corresponding to a set of advertisements presented in association with the set of browsing results, in which the surfaces are for presenting a summarized review for each item included among the set of browsing results and the set of advertisements.

The embedding generation module 216 generates a review embedding for each review for an item based on the review. The embedding generation module 216 may do so via an LLM-based indexing technique that converts reviews to embeddings (e.g., using GPT Index, LangChain, LlamaIndex, or any other suitable type of data framework). For example, suppose that an item, such as a bottle of wine, has several reviews that indicate the wine is a good value (e.g., “compared favorably to higher-end wines,” “tastes more expensive than it is,” etc.) and pairs well with other foods (e.g., “pairs well with steak, red meat, pasta, pizza, and dark chocolate desserts,” “versatile and can be enjoyed with various dishes,” etc.). In the above example, the information included in the reviews may be used by the embedding generation module 216 to generate review embeddings for the reviews for the bottle of wine in an embedding space, in which each review embedding represents nuances of a corresponding review that may be of interest to customers, such as the reasons that the wine is a good value and the types of foods with which the wine pairs well. In embodiments in which a review for an item includes content other than text (e.g., one or more images or videos), the embedding generation module 216 may generate a review embedding for the review based on textual information associated with the content (e.g., metadata associated with an image, a transcript of dialogue included in a video, etc.). The embedding generation module 216 may generate a review embedding for a review using one or more machine learning models and may update the review embedding (e.g., if the review is updated by a customer). Once a review embedding for a review for an item is generated, the review embedding may be stored in the data store 240 in association with item data (e.g., an item identifier) for the item.

The embedding generation module 216 also generates a user embedding for a customer based on a set of contextual information associated with the customer or customer data associated with the customer. The embedding generation module 216 may do so using an LLM embedding generator that converts contextual or other user-specific details into embeddings or using any other suitable technique or combination of techniques. As described above, a set of contextual information associated with a customer may describe the context in which a set of summarized reviews for a set of items may be presented to the customer. For example, suppose that a set of contextual information associated with a customer describes one or more surfaces (e.g., a set of search results, a set of browsing results, a set of advertisements, etc.) for presenting a set of summarized reviews for a set of items and a set of items included in a shopping list associated with the customer. In this example, the embedding generation module 216 may generate a user embedding for the customer based on the set of contextual information associated with the customer, in which the user embedding represents details of the set of contextual information (e.g., the type(s) of surface(s), information describing each item included in the shopping list, etc.) in an embedding space. In the above example, the embedding generation module 216 also may retrieve customer data associated with the customer, such as demographic information or a set of interests or preferences associated with the customer (e.g., brands and item types the customer prefers), historical order or historical interaction information associated with the customer, etc. and generate the user embedding for the customer based on the customer data. The embedding generation module 216 may generate a user embedding for a customer using one or more machine learning models and may update the user embedding as a set of contextual information or customer data associated with the customer is updated (e.g., as the customer adds items to their shopping list, as the customer updates their preferences, as a surface for presenting a set of summarized reviews for a set of items changes, etc.). Once the user embedding for the customer is generated, the user embedding may be stored in the data store 240 in association with customer data for the customer.

The review identification module 217 may retrieve review embeddings and user embeddings from the data store 240. The review identification module 217 may retrieve the embeddings in response to a request for information describing a set of items. For example, suppose that the interface generation module 211 receives a search query for “bread” from a customer client device 100 associated with a customer. In this example, the item scoring module 212 then scores items based on a relatedness of the items to the search query, the item ranking module 213 ranks the items based on their scores, and the item identification module 214 identifies items with scores that exceed some threshold. Continuing with this example, the review identification module 217 may retrieve a user embedding for the customer and a review embedding for each review for each item identified by the item identification module 214 (e.g., based on an item identifier for the item).

The review identification module 217 also identifies a set of reviews for each item included among a set of items, in which the set of reviews is likely to be relevant to a customer. The review identification module 217 may do so by comparing a user embedding generated for the customer to a set of review embeddings generated for each item and identifying a set of reviews for each item based on the comparison. For example, for each item included among a set of items identified by the item identification module 214, the review identification module 217 may compare a user embedding to each review embedding generated for each review for the item by determining a measure of similarity between the user embedding and the review embedding (e.g., based on a cosine similarity, a Euclidean distance, a dot product, etc.). In this example, the review identification module 217 may then identify a set of reviews for each item based on the comparison, in which each identified review is associated with a review embedding having at least a threshold measure of similarity to the user embedding. Once a set of reviews for each item have been identified, information identifying each set of reviews may be used to generate a prompt, as further described below.

The prompt generation module 218 generates a prompt to a large language model (LLM) for a summarized review for each item included among a set of items. The LLM is a trained deep-learning model (e.g., GPT-4) that generates a textual output based on the prompt, while the prompt is a question that the textual output of the LLM should answer. In some embodiments, the LLM is trained by the machine learning training module 230, which is described below. The prompt generation module 218 may generate the prompt based on the reviews to be summarized, information associated with a customer (e.g., a request received from a customer client device 100 associated with the customer for information describing the set of items, contextual information associated with the customer, customer data associated with the customer, etc.), or based on any other suitable types of information.

A prompt generated by the prompt generation module 218 may include various components. The prompt may include a request to summarize, for a customer, a set of reviews for each item included among a set of items and the set of reviews for each item to be summarized. The prompt also may include information associated with the customer (e.g., demographic or other customer data associated with the customer, a set of contextual information associated with the customer, etc.). The prompt further may include guidelines for summarizing the set of reviews for each item (e.g., to limit each summarized review to a character or word limit, to include and highlight words or brands that are likely to be relevant to the customer, to prioritize words that appear most frequently and that are also unique to each corresponding item, etc.). For example, a prompt generated by the prompt generation module 218 in response to a search query may state: “Given the following contextual information associated with a customer and reviews for each item, summarize, for the customer, the reviews for each item into a sentence that is less than 50 words explaining why the item is unique.” Alternatively, in the above example, the prompt generated by the prompt generation module 218 may state: “Given the following contextual information associated with a customer and reviews for each item, summarize the reviews for each item into a sentence that is less than 50 words explaining why the item might appeal to the customer.” In this example, the prompt may also include the referenced contextual information and reviews. Once the prompt is generated by the prompt generation module 218, the prompt may be provided to the LLM, as further described below.

In some embodiments, the prompt generation module 218 generates multiple prompts to the LLM for a set of summarized reviews for a set of items. For example, for each surface (e.g., a set of search results, a set of browsing results, a set of advertisements, etc.) for presenting a set of summarized reviews for a set of items, the prompt generation module 218 may generate multiple prompts to the LLM for the set of summarized reviews. In such embodiments, the prompt generation module 218 selects a prompt based on previous interactions by a customer with items that indicate the performance of each prompt. For example, suppose that the interface generation module 211 receives a request for information describing a set of items from a customer client device 100 associated with a customer and that a set of contextual information associated with the customer indicates that the information is to be presented via a surface corresponding to a set of browsing results. In this example, the prompt generation module 218 may generate a first prompt that states: “Given the following contextual information associated with a customer and reviews for each item, summarize the reviews for each item into a sentence that is less than 50 words explaining why the customer should be using the item.” Continuing with this example, the prompt generation module 218 also may generate a second prompt that states: “Given the following contextual information associated with a customer and reviews for each item, summarize, for the customer, the reviews for each item into a sentence that is less than 50 words explaining why the item is popular among customers.” In the above example, the prompts may also include the referenced contextual information and reviews. Furthermore, in the above example, suppose that both prompts previously were provided to the LLM to obtain an output including a summarized review for each item that was presented via a similar surface. In this example, the prompt generation module 218 may select a prompt based on the results of one or more offline evaluation methods (e.g., modeling the behavior of the LLM) or an A/B test (e.g., whether using the first prompt or the second prompt resulted in or was likely to result in the customer ordering more items associated with summarized reviews or adding more items associated with summarized reviews to their shopping list).

The review summarization module 219 provides a prompt to the LLM, which generates a textual output based on the prompt. The review summarization module 219 subsequently may receive the textual output from the LLM, which includes a set of summarized reviews for a set of items. For example, the review summarization module 219 may provide a prompt to the LLM, in which the prompt includes contextual information associated with a current session of a customer with the online system 140, an order history associated with the customer, a set of reviews for each item included among a set of items, and a request to summarize, for the customer, the set of reviews for each item. In this example, the review summarization module 219 may then receive an output from the LLM, in which the output includes a set of summarized reviews for the set of items. In some embodiments, the review summarization module 219 provides multiple prompts to the LLM and the LLM may generate multiple textual outputs, in which each textual output includes a subset of a set of summarized reviews for a set of items. For example, the review summarization module 219 may provide multiple prompts to the LLM, in which each prompt includes information associated with a customer, reviews for one of multiple items, and a request to summarize the reviews for the customer. In this example, each output from the LLM received by the review summarization module 219 may include a summarized review for a corresponding item. The LLM may generate a summarized review for an item based on a set of guidelines included in a prompt. In the above examples, based on a set of guidelines also included in each prompt, each summarized review for an item may have a length that does not exceed a character or word limit, include and highlight words or brands that are likely to be relevant to the customer, prioritize words that appear most frequently and that are also unique to the item, etc.

The review summarization module 219 may provide a prompt to the LLM in various ways. In some embodiments, the review summarization module 219 pre-loads information associated with one or more customers or a set of reviews for one or more items into the LLM, which generates an output when a prompt is received. In such embodiments, the prompt generated by the prompt generation module 218 may include information identifying a set of reviews for one or more items to be summarized or a customer for which the set of reviews for the item(s) is to be summarized. In some embodiments, the review summarization module 219 provides one or more prompts to a single instance of the LLM, such that review summaries for multiple items may be generated based on a queue. In other embodiments, the review summarization module 219 provides a prompt to each of multiple instances of the LLM that each generate a textual output including a summarized review for an item based on the prompt, such that outputs including summarized reviews for multiple items may be generated in parallel. In such embodiments, the review summarization module 219 may pre-load information associated with one or more customers or a set of reviews for one or more items into one or more instances of the LLM and the review summarization module 219 may send a prompt to an appropriate instance of the LLM (e.g., for a set of corresponding items, for a surface, etc.).

Once the LLM generates a textual output including a summarized review for an item based on a prompt provided by the review summarization module 219, the interface generation module 211 sends the textual output for display to a customer client device 100 associated with a customer. The interface generation module 211 may do so via a user interface. For example, the interface generation module 211 may generate a user interface that includes each item included among a set of items and a summarized review for each item and send the user interface for display to a customer client device 100. Alternatively, in the above example, the user interface sent for display to the customer client device 100 may include the set of items and, as a summarized review for each item included among the set of items is output by the LLM, the interface generation module 211 may update the user interface with the summarized review. A summarized review for an item may be presented in association with other types of information associated with the item. In the above example, each summarized review may be displayed in association with a name of a corresponding item, a description of the item, a price of the item, one or more images or videos of the item, one or more ingredients/materials included in the item, an average rating for the item, etc.

To illustrate an example of a summarized review for an item that is sent for display to a customer client device 100 associated with a customer, suppose that the interface generation module 211 receives a search query from the customer client device 100 for “wine for steak” and that the set of search results includes multiple items corresponding to bottles of red wine. In this example, a summarized review for an item corresponding to a bottle of Cabernet Sauvignon red wine that is sent for display to the customer client device 100 may read: “Pairs well with steak, red meat, pasta, pizza, and dark chocolate desserts,” which may have been generated based on one or more reviews for the bottle of wine. In the above example, suppose that the interface generation module 211 subsequently receives an additional request to browse items included in a “great value” item category from the customer client device 100 associated with the customer and that the bottle of Cabernet Sauvignon red wine is also included in the set of browsing results, which includes multiple items that are on sale. In this example, based on the surface in which the summarized review for the bottle of wine is presented and a preference associated with the customer for expensive wines, the summarized review for the bottle of wine may read: “Wine tastes more expensive than it is,” which may have been generated based on one or more additional reviews for the bottle of wine.

The order management module 220 manages orders for items from customers. The order management module 220 receives orders from customer client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit instructions to the picker client device 110 to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. The online system 140 may use machine learning models to perform functionalities described herein. Example machine learning models include regression models, support vector machines, naïve bayes, decision trees, k-nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, large language models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores user data (e.g., customer data or picker data), item data, object data, order data, and session data, for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

### Context-Based Generation of Summarized Reviews Using a Large Language Model

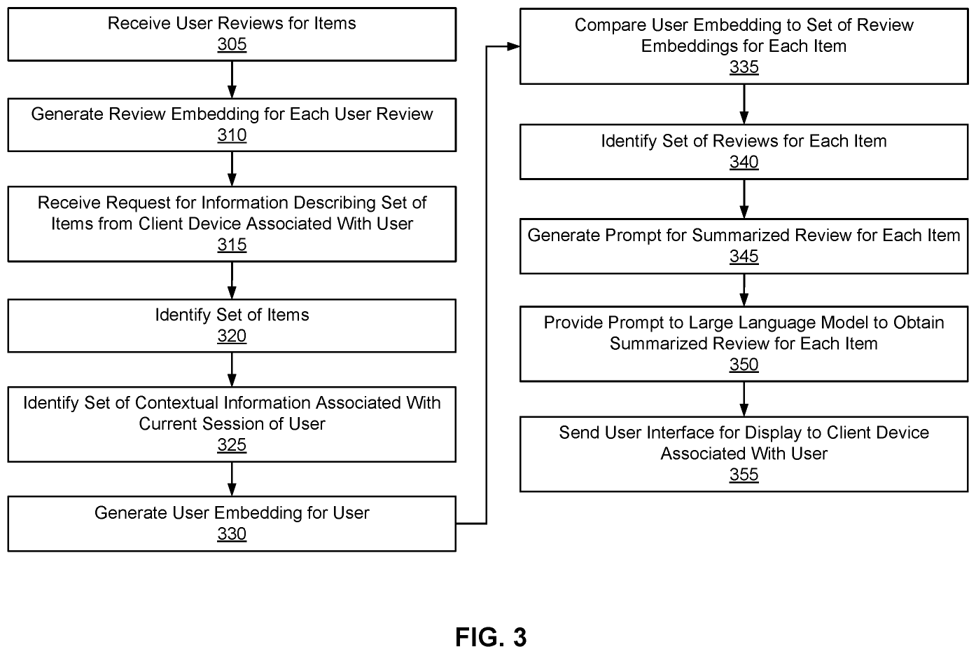

FIG. 3 is a flowchart of a method for generating summarized reviews for items using a large language model based on contextual information associated with a user of an online system 140, in accordance with one or more embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

The online system 140 receives (step 305, e.g., via the data collection module 200) reviews for items included among one or more inventories of one or more retailers associated with the online system 140, in which each review is associated with an item. The reviews may be received 305 from customer client devices 100 associated with customers. Each review for an item may include various components, such as a title of the review, information identifying a customer who provided the review, a date that the customer provided the review, a rating for the item (e.g., one to five stars) and additional information (e.g., text, images, or videos) describing a reason for the rating (e.g., features about the item that the customer liked or disliked, whether the customer would recommend the item, etc.). Additionally, each review for an item may be stored (e.g., in the data store 240) in association with item data (e.g., an item identifier) for the item.

The online system 140 then generates 310 (e.g., using the embedding generation module 216) a review embedding for each review for an item based on the review. The online system 140 may do so via an LLM-based indexing technique that converts reviews to embeddings (e.g., using GPT Index, LangChain, LlamaIndex, or any other suitable type of data framework). For example, suppose that an item, such as a bottle of wine, has several reviews that indicate the wine is a good value (e.g., “compared favorably to higher-end wines,” “tastes more expensive than it is,” etc.) and pairs well with other foods (e.g., “pairs well with steak, red meat, pasta, pizza, and dark chocolate desserts,” “versatile and can be enjoyed with various dishes,” etc.). In the above example, the information included in the reviews may be used by the online system 140 to generate (step 310) review embeddings for the reviews for the bottle of wine in an embedding space, in which each review embedding represents nuances of a corresponding review that may be of interest to customers, such as the reasons that the wine is a good value and the types of foods with which the wine pairs well. In embodiments in which a review for an item includes content other than text (e.g., one or more images or videos), the online system 140 may generate 310 a review embedding for the review based on textual information associated with the content (e.g., metadata associated with an image, a transcript of dialogue included in a video, etc.). The online system 140 may generate 310 a review embedding for a review using one or more machine learning models and may update the review embedding (e.g., if the review is updated by a customer). Once a review embedding for a review for an item is generated 310, the review embedding may be stored (e.g., in the data store 240) in association with item data (e.g., an item identifier) for the item.

The online system 140 receives 315 (e.g., via the interface generation module 211) a request from a customer client device 100 associated with a customer for information describing a set of items. The information describing the set of items may be presented via one or more surfaces, such as a set of search results, a set of browsing results, a set of advertisements, etc. For example, if the request received 315 from the customer client device 100 is a request to browse a set of items, information describing the set of items may be presented via a surface corresponding to a set of browsing results. As an additional example, if the request received 315 from the customer client device 100 is a request to access an ordering interface that includes one or more advertisements for one or more items, information describing the item(s) may be presented via a surface corresponding to the advertisement(s).

Responsive to the request, the online system 140 identifies 320 (e.g., using the item scoring module 212, the item ranking module 213, or the item identification module 214) the set of items. For example, suppose that the request received 315 from the customer client device 100 is a search query. In this example, the online system 140 may score (e.g., using the item scoring module 212) items included among one or more inventories of one or more retailers associated with the online system 140 based on a relatedness of the items to the search query. In this example, the online system 140 may rank (e.g., using the item ranking module 213) the items based on their scores and identify 320 (e.g., using the item identification module 214) the set of items, in which the set of items have scores that exceed some threshold (e.g., the top n items or the p percentile of items). As an additional example, if the request received 315 from the customer client device 100 is a request for a set of browsing results for items included in a “great value” item category, the online system 140 similarly may score items included among one or more inventories of one or more retailers associated with the online system 140 based on a relatedness of the items to the item category, rank the items based on their scores, and identify 320 the set of items, in which the set of items have scores that exceed some threshold.

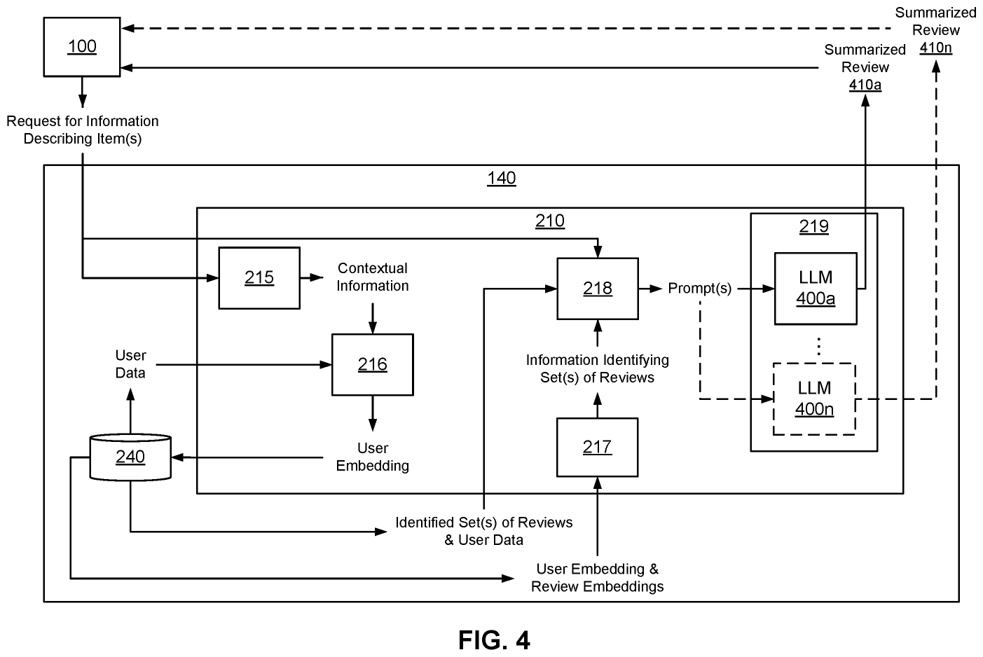

Responsive to the request, the online system 140 also identifies 325 (e.g., using the context identification module 215) a set of contextual information associated with the customer. The set of contextual information associated with the customer may describe a context in which a set of summarized reviews for the set of items may be presented to the customer. For example, the set of contextual information associated with the customer may describe one or more surfaces (e.g., a set of search results, a set of browsing results, a set of advertisements, etc.) for presenting the set of summarized reviews for the set of items. The online system 140 may identify 325 the set of contextual information associated with the customer based on a set of session data describing a current session of the customer (e.g., the request for information describing the set of items received 315 from the customer client device 100 associated with the customer, a set of items included in a shopping list associated with the customer, etc.). FIG. 4 is a process flow diagram for generating summarized reviews for items using a large language model based on contextual information associated with a user of an online system 140, in accordance with one or more embodiments. As shown in FIG. 4, the set of contextual information associated with the customer may be identified 325 based on the request received 315 from the customer client device 100 associated with the customer (e.g., whether the customer has requested information describing the set of items in the context of a set of search results, a set of browsing results, a set of advertisements, etc.).

To illustrate an example of how the online system 140 may identify 325 the set of contextual information associated with the customer, suppose that the request for information describing the set of items corresponds to a search query. In this example, the set of contextual information associated with the customer identified 325 by the online system 140 may include a surface corresponding to a set of search results for presenting a summarized review for each of the set of items included among the set of search results. In the above example, suppose also that the search query is for cheese and that items included in a shopping list associated with the customer include basil, ciabatta bread, and tomatoes. In this example, the set of contextual information associated with the customer may indicate that the summarized review for each item may describe cheeses that go well with basil, ciabatta bread, and tomatoes. As an additional example, suppose that the request for information describing the set of items corresponds to a request to browse items included in a “great value” item category. In this example, the set of contextual information associated with the customer may include a surface corresponding to a set of browsing results for a set of items that are on sale and an additional surface corresponding to a set of advertisements presented in association with the set of browsing results, in which the surfaces are for presenting a summarized review for each item included among the set of browsing results and the set of advertisements.

Referring back to FIG. 3, responsive to the request, the online system 140 also generates 330 (e.g., using the embedding generation module 216) a user embedding for the customer based on the set of contextual information associated with the customer or customer data associated with the customer (shown in FIG. 4). The online system 140 may generate 330 the user embedding using an LLM embedding generator that converts contextual or other user-specific details into embeddings or using any other suitable technique or combination of techniques. As described above, the set of contextual information associated with the customer may describe the context in which the set of summarized reviews for the set of items may be presented to the customer. For example, suppose that the set of contextual information associated with the customer describes one or more surfaces for presenting the set of summarized reviews for the set of items and a set of items included in a shopping list associated with the customer. In this example, the online system 140 may generate 330 the user embedding for the customer based on the set of contextual information associated with the customer, in which the user embedding represents details of the set of contextual information (e.g., the type(s) of surface(s), information describing each item included in the shopping list, etc.) in an embedding space. In the above example, the online system 140 also may retrieve (e.g., using the embedding generation module 216) customer data associated with the customer, such as demographic information or a set of interests or preferences associated with the customer (e.g., brands and item types the customer prefers), historical order or historical interaction information associated with the customer, etc. and generate 330 the user embedding for the customer based on the customer data. The online system 140 may generate 330 the user embedding for the customer using one or more machine learning models and may update the user embedding as the set of contextual information or customer data associated with the customer is updated (e.g., as the customer adds items to their shopping list, as the customer updates their preferences, as a surface for presenting the set of summarized reviews for the set of items changes, etc.). Once the user embedding for the customer is generated 330, the user embedding may be stored (e.g., in the data store 240) in association with customer data for the customer.

Responsive to the request, the online system 140 may retrieve (e.g., using the review identification module 217) a set of review embeddings for each item included among the set of items and the user embedding for the customer (e.g., from the data store 240) and identify 340 (e.g., using the review identification module 217), for each item, a set of reviews likely to be relevant to the customer. The online system 140 may do so by comparing (e.g., using the review identification module 217) the user embedding generated 330 for the customer to the set of review embeddings generated 310 for each item included among the set of items and identifying 340 the set of reviews for each item based on the comparison. For example, for each item included among the set of items, the online system 140 may compare the user embedding to each review embedding generated 310 for each review for the item by determining a measure of similarity between the user embedding and the review embedding (e.g., based on a cosine similarity, a Euclidean distance, a dot product, etc.). In this example, the online system 140 may then identify 340 the set of reviews for each item based on the comparison, in which each identified review is associated with a review embedding having at least a threshold measure of similarity to the user embedding. As shown in FIG. 4, once the set of reviews for each item have been identified 340, information identifying each set of reviews may be used to generate 345 a prompt, as further described below.

Referring again to FIG. 3, responsive to the request, the online system 140 also generates 345 (e.g., using the prompt generation module 218) a prompt to a large language model (LLM) for a summarized review for each item included among the set of items. The LLM is a trained deep-learning model (e.g., GPT-4) that generates a textual output based on the prompt, while the prompt is a question that the textual output of the LLM should answer. In some embodiments, the LLM is trained by the online system 140 (e.g., using the machine learning training module 230). As shown in FIG. 4, the online system 140 may generate 345 the prompt based on customer data associated with the customer and the set of reviews identified 340 for each item included among the set of items. The online system 140 also may generate 345 the prompt based on other types of information associated with the customer (e.g., the request received 315 from the customer client device 100 associated with the customer for information describing the set of items, the set of contextual information associated with the customer, etc.) or based on any other suitable types of information.

The prompt generated 345 by the online system 140 may include various components. The prompt may include a request to summarize, for the customer, the identified set of reviews for each item and the identified set of reviews for each item to be summarized. The prompt also may include information associated with the customer (e.g., demographic or other customer data associated with the customer, the set of contextual information associated with the customer, etc.). The prompt further may include guidelines for summarizing the identified set of reviews for each item (e.g., to limit each summarized review to a character or word limit, to include and highlight words or brands that are likely to be relevant to the customer, to prioritize words that appear most frequently and that are also unique to each corresponding item, etc.). For example, if the request received 315 from the customer client device 100 corresponds to a search query, the prompt generated 345 by the online system 140 may state: “Given the following contextual information associated with a customer and reviews for each item, summarize, for the customer, the reviews for each item into a sentence that is less than 50 words explaining why the item is unique.” Alternatively, in the above example, the prompt generated 345 by the online system 140 may state: “Given the following contextual information associated with a customer and reviews for each item, summarize the reviews for each item into a sentence that is less than 50 words explaining why the item might appeal to the customer.” In this example, the prompt may also include the referenced contextual information and reviews. Once the prompt is generated 345 by the online system 140, the prompt may be provided to the LLM, as further described below.

In some embodiments, the online system 140 generates (step 345) multiple prompts to the LLM for the set of summarized reviews for the set of items. For example, for each surface (e.g., a set of search results, a set of browsing results, a set of advertisements, etc.) for presenting the set of summarized reviews for the set of items, the online system 140 may generate (step 345) multiple prompts to the LLM for the set of summarized reviews. In such embodiments, the online system 140 selects (e.g., using the prompt generation module 218) a prompt based on previous interactions by the customer with items that indicate the performance of each prompt. For example, suppose that the set of contextual information associated with the customer indicates that the information describing the set of items is to be presented via a surface corresponding to a set of browsing results. In this example, the online system 140 may generate 345 a first prompt that states: “Given the following contextual information associated with a customer and reviews for each item, summarize the reviews for each item into a sentence that is less than 50 words explaining why the customer should be using the item.” Continuing with this example, the online system 140 also may generate 345 a second prompt that states: “Given the following contextual information associated with a customer and reviews for each item, summarize, for the customer, the reviews for each item into a sentence that is less than 50 words explaining why the item is popular among customers.” In the above example, the prompts may also include the referenced contextual information and reviews. Furthermore, in the above example, suppose that both prompts previously were provided to the LLM to obtain an output including a summarized review for each item that was presented via a similar surface. In this example, the online system 140 may select a prompt based on the results of one or more offline evaluation methods (e.g., modeling the behavior of the LLM) or an A/B test (e.g., whether using the first prompt or the second prompt resulted in or was likely to result in the customer ordering more items associated with summarized reviews or adding more items associated with summarized reviews to their shopping list).

Referring back to FIG. 3, the online system 140 provides 350 (e.g., using the review summarization module 219) the prompt to the LLM, which generates a textual output based on the prompt. The online system 140 subsequently may receive (e.g., via the review summarization module 219) the textual output from the LLM, which includes a set of summarized reviews for the set of items. For example, the online system 140 may provide 350 the prompt to the LLM, in which the prompt includes the set of contextual information associated with the current session of the customer with the online system 140, an order history associated with the customer, the identified set of reviews for each item included among the set of items, and a request to summarize, for the customer, the identified set of reviews for each item. In this example, the online system 140 may then receive an output from the LLM, in which the output includes the set of summarized reviews for the set of items. In some embodiments, the online system 140 provides (step 350) multiple prompts to the LLM and the LLM may generate multiple textual outputs, in which each textual output includes a subset of the set of summarized reviews for the set of items. For example, if the identified set of items includes multiple items, the online system 140 may provide (step 350) multiple prompts to the LLM, in which each prompt includes information associated with the customer, reviews for one of the items, and a request to summarize the reviews for the customer. In this example, each output from the LLM received by the online system 140 may include a summarized review for a corresponding item. The LLM may generate a summarized review for an item based on a set of guidelines included in the prompt. In the above examples, based on a set of guidelines also included in each prompt, each summarized review for an item may have a length that does not exceed a character or word limit, include and highlight words or brands that are likely to be relevant to the customer, prioritize words that appear most frequently and that are also unique to the item, etc.

The online system 140 may provide 350 the prompt to the LLM in various ways. In some embodiments, the online system 140 pre-loads (e.g., using the review summarization module 219) information associated with the customer or the identified set of reviews for the set of items into the LLM, which generates the output when the prompt is received. In such embodiments, the prompt generated 345 by the online system 140 may include information identifying the set of reviews for each item of the set of items to be summarized or the customer for which the set of reviews for each item is to be summarized. In some embodiments, the online system 140 provides 350 one or more prompts to a single instance of the LLM, such that review summaries for multiple items may be generated based on a queue. As shown in FIG. 4, in other embodiments, the online system 140 provides 350 a prompt to each of multiple instances of the LLM 400a-n that each generate a textual output including a summarized review 410a-n for an item based on the prompt, such that outputs including summarized reviews 410a-n for multiple items may be generated in parallel. In such embodiments, the online system 140 may pre-load information associated with the customer and the identified set of reviews for each item included among the set of items into one or more instances of the LLM 400a-n and the online system 140 may send a prompt to an appropriate instance of the LLM 400a-n (e.g., for the set of corresponding items, for a surface, etc.).

Referring once more to FIG. 3, once the LLM 400 generates the textual output including a summarized review 410 for each item based on the prompt provided 350 by the online system 140, the online system 140 sends 355 (e.g., via the interface generation module 211) the textual output for display to the customer client device 100 associated with the customer. The online system 140 may do so via a user interface. For example, the online system 140 may generate (e.g., using the interface generation module 211) a user interface that includes each item included among the set of items and a summarized review 410 for each item and send 355 the user interface for display to the customer client device 100. Alternatively, in the above example, the user interface sent 355 for display to the customer client device 100 may include the set of items and, as shown in FIG. 4, as a summarized review 410a-n for each item is output by an instance of the LLM 400a-n, the online system 140 may update the user interface with the summarized review 410a-n. A summarized review 410 for an item may be presented in association with other types of information associated with the item. In the above example, each summarized review 410a-n may be displayed in association with a name of a corresponding item, a description of the item, a price of the item, one or more images or videos of the item, one or more ingredients/materials included in the item, an average rating for the item, etc.

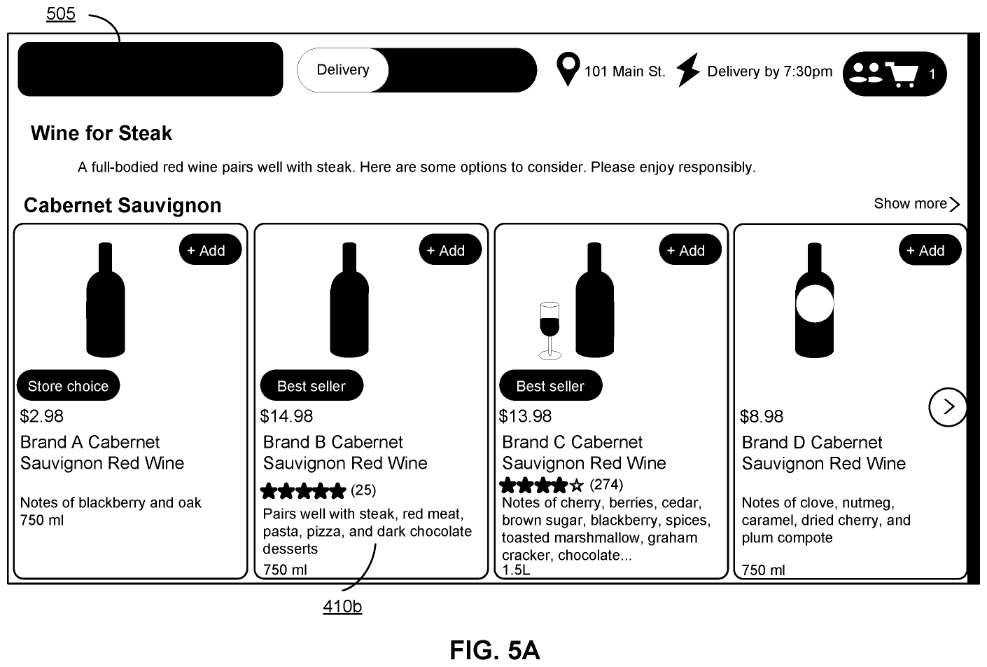

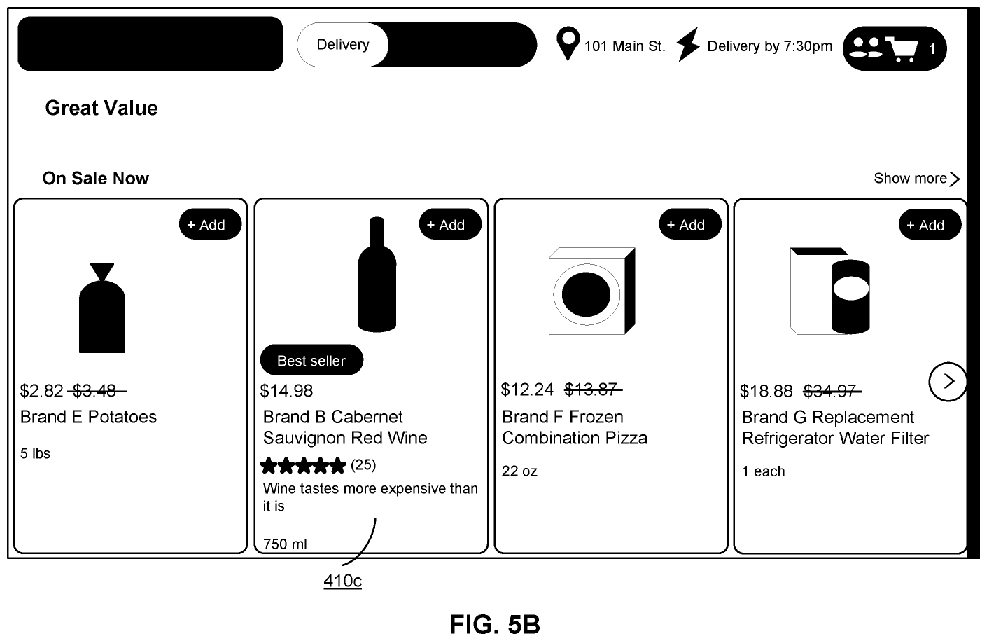

FIGS. 5A and 5B illustrate examples of summarized reviews 410 for an item based on contextual information associated with a user of an online system 140, in accordance with one or more embodiments. Referring first to FIG. 5A, suppose that the request for information describing the set of items received 315 from the customer client device 100 corresponds to a search query 505 for “wine for steak” and that the set of search results includes multiple items corresponding to bottles of Cabernet Sauvignon red wine. In this example, a summarized review 410b for an item corresponding to a bottle of Brand B Cabernet Sauvignon red wine that is sent 355 for display to the customer client device 100 may read: “Pairs well with steak, red meat, pasta, pizza, and dark chocolate desserts,” which may have been generated based on one or more reviews for the bottle of wine. In the above example, suppose that the online system 140 subsequently receives 315 an additional request from the customer client device 100 to browse items included in a “great value” item category and that the bottle of Brand B Cabernet Sauvignon red wine is also included in the set of browsing results, which includes multiple items that are on sale, as shown in FIG. 5B. In this example, based on the surface in which the summarized review 410c for the bottle of Brand B Cabernet Sauvignon red wine is presented and a preference associated with the customer for expensive wines, the summarized review 410c for the bottle of wine may read: “Wine tastes more expensive than it is,” which may have been generated based on one or more additional reviews for the bottle of wine.

In some embodiments, the online system 140 performs some or all of the steps described above with respect to a user of the online system 140 other than a customer. Examples of such types of a user include: a picker, a retailer, or any other individual or entity utilizing the online system 140. Furthermore, in various embodiments, the online system 140 performs some or all of the steps described above with respect to objects other than items. Examples of such types of objects include: coupons, recipes, advertisements, applications (e.g., gaming applications), locations (e.g., tourist locations), businesses (e.g., restaurants), or any other suitable types of objects for which users may provide reviews. For example, the online system 140 may receive (step 305) reviews for objects from users of the online system 140, in which each review is associated with an object and the online system 140 may then generate 310 a review embedding for each review for each object based on the review. In this example, the online system 140 then receives 315 a request for information describing a set of objects from a device (e.g., a picker client device 110) or a computing system (e.g., a retailer computing system 120) that a user (e.g., a picker or a retailer computing system 120) of the online system 140 may use to interact with the online system 140. In the above example, the online system 140 then identifies 320 the set of objects. In this example, the online system 140 also identifies 325 a set of contextual information associated with a current session of the user with the online system 140 and generates 330 a user embedding for the user based on the contextual information. Continuing with this example, the online system 140 compares 335 the user embedding to a set of review embeddings for each object of the set of objects and identifies 340 a set of reviews for each object of the set of objects based on the comparison. In the above example, the online system 140 generates 345 a prompt to the LLM 400 for a summarized review 410 for each object included among the set of objects and provides 350 the prompt to the LLM 400 that generates a textual output based on the prompt, in which the prompt includes a request to summarize, for the customer, the set of reviews for each object, the set of reviews for each object to be summarized, or information associated with the customer. In the above example, the online system 140 then sends 355 a user interface for display to the device or computing system associated with the user, in which the user interface includes the set of objects and the summarized review 410 for each object of the set of objects.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online system, a plurality of user reviews for a plurality of items included among one or more inventories of one or more retailers associated with the online system, wherein each user review of the plurality of user reviews is associated with an item of the plurality of items;
generating a review embedding for each user review for each item of the plurality of items based at least in part on a corresponding user review for a corresponding item;
receiving, from a client device associated with a user of the online system, a request for information describing a set of items; and
responsive to the received request:
identifying the set of items;
identifying contextual information associated with a current session of the user with the online system;
generating a user embedding for the user based at least in part on user data associated with the user and the identified contextual information associated with the user;
comparing the user embedding to a set of review embeddings for each item of the set of items;
identifying a set of user reviews for each item of the set of items based at least in part on the comparing;
generating a prompt for a summarized review for each item of the set of items, wherein the prompt comprises the identified set of user reviews for each item of the set of items and a request to summarize, for the user, the identified set of user reviews for each item of the set of items;
providing the prompt to a large language model to obtain the summarized review for each item of the set of items; and
sending a user interface for display to the client device associated with the user, wherein the user interface comprises the set of items and the summarized review for each item of the set of items.

2. The method of claim 1, wherein identifying the contextual information associated with the current session of the user with the online system comprises:
identifying one or more surfaces for presenting the summarized review for each item of the set of items, wherein the one or more surfaces comprise one or more selected from the group consisting of: a set of search results, a set of browsing results, and a set of advertisements.

3. The method of claim 1, wherein identifying the contextual information associated with the current session of the user with the online system is based at least in part on information describing one or more of: the received request for information describing the set of items and a set of items included in a shopping list associated with the user.

4. The method of claim 1, further comprising:
generating a plurality of prompts for the summarized review for each item of the set of items; and
selecting a prompt from the plurality of prompts based at least in part on a set of previous interactions by the user with one or more items that indicate a performance of each prompt of the plurality of prompts.

5. The method of claim 4, wherein selecting the prompt from the plurality of prompts is based at least in part on one or more of: an offline evaluation method for the plurality of prompts and a result of an A/B test performed on the plurality of prompts.

6. The method of claim 1, wherein generating the user embedding for the user comprises:
retrieving the user data associated with the user, wherein the user data comprises one or more selected from the group consisting of: a set of demographic information associated with the user, a set of interests associated with the user, a set of orders placed by the user with the online system, and a set of interactions by the user with the online system; and
generating the user embedding for the user based at least in part on the user data associated with the user.

7. The method of claim 1, wherein receiving the plurality of user reviews for the plurality of items included among the one or more inventories of the one or more retailers associated with the online system comprises:
receiving one or more selected from the group consisting of: a title for a corresponding user review, information identifying a user associated with a corresponding user review, a date that a corresponding user review was received, a rating associated with an item, and information describing a reason for the rating.

8. The method of claim 1, wherein generating the review embedding for each user review for each item of the plurality of items is based at least in part on one or more types of content included in the corresponding user review for the corresponding item, the one or more types of content selected from the group consisting of: text content, image content, and video content.

9. The method of claim 1, wherein comparing the user embedding to the set of review embeddings for each item of the set of items comprises:
determining a measure of similarity between the user embedding and each review embedding of the set of review embeddings, wherein the measure of similarity is selected from the group consisting of: a cosine similarity, a Euclidean distance, and a dot product.

10. The method of claim 1, wherein the client device associated with the user is an augmented reality device.

11. A computer program product comprising a non-transitory computer-readable storage medium having instructions encoded thereon that, when executed by a processor, cause the processor to perform steps comprising:
receive, at an online system, a plurality of user reviews for a plurality of items included among one or more inventories of one or more retailers associated with the online system, wherein each user review of the plurality of user reviews is associated with an item of the plurality of items;
generate a review embedding for each user review for each item of the plurality of items based at least in part on a corresponding user review for a corresponding item;
receive, from a client device associated with a user of the online system, a request for information describing a set of items; and
responsive to the received request:
identify the set of items;
identify contextual information associated with a current session of the user with the online system;
generate a user embedding for the user based at least in part on user data associated with the user and the identified contextual information associated with the user;
compare the user embedding to a set of review embeddings for each item of the set of items;
identify a set of user reviews for each item of the set of items based at least in part on the comparing;
generate a prompt for a summarized review for each item of the set of items, wherein the prompt comprises the identified set of user reviews for each item of the set of items and a request to summarize, for the user, the identified set of user reviews for each item of the set of items;
provide the prompt to a large language model to obtain the summarized review for each item of the set of items; and
send a user interface for display to the client device associated with the user, wherein the user interface comprises the set of items and the summarized review for each item of the set of items.

12. The computer program product of claim 11, wherein identify the contextual information associated with the current session of the user with the online system comprises:
identify one or more surfaces for presenting the summarized review for each item of the set of items, wherein the one or more surfaces comprise one or more selected from the group consisting of: a set of search results, a set of browsing results, and a set of advertisements.

13. The computer program product of claim 11, wherein identify the contextual information associated with the current session of the user with the online system is based at least in part on information describing one or more of: the received request for information describing the set of items and a set of items included in a shopping list associated with the user.

14. The computer program product of claim 11, wherein the computer-readable storage medium further has instructions encoded thereon that, when executed by the processor, cause the processor to perform steps comprising:
generate a plurality of prompts for the summarized review for each item of the set of items; and
select a prompt from the plurality of prompts based at least in part on a set of previous interactions by the user with one or more items that indicate a performance of each prompt of the plurality of prompts.

15. The computer program product of claim 14, wherein select the prompt from the plurality of prompts is based at least in part on one or more of: an offline evaluation method for the plurality of prompts and a result of an A/B test performed on the plurality of prompts.

16. The computer program product of claim 11, wherein generate the user embedding for the user comprises:
retrieve the user data associated with the user, wherein the user data comprises one or more selected from the group consisting of: a set of demographic information associated with the user, a set of interests associated with the user, a set of orders placed by the user with the online system, and a set of interactions by the user with the online system; and
generate the user embedding for the user based at least in part on the user data associated with the user.

17. The computer program product of claim 11, wherein receive the plurality of user reviews for the plurality of items included among the one or more inventories of the one or more retailers associated with the online system comprises:
receive one or more selected from the group consisting of: a title for a corresponding user review, information identifying a user associated with a corresponding user review, a date that a corresponding user review was received, a rating associated with an item, and information describing a reason for the rating.

18. The computer program product of claim 11, wherein generate the review embedding for each user review for each item of the plurality of items is based at least in part on one or more types of content included in the corresponding user review for the corresponding item, the one or more types of content selected from the group consisting of: text content, image content, and video content.

19. The computer program product of claim 11, wherein compare the user embedding to the set of review embeddings for each item of the set of items comprises:
determine a measure of similarity between the user embedding and each review embedding of the set of review embeddings, wherein the measure of similarity is selected from the group consisting of: a cosine similarity, a Euclidean distance, and a dot product.

20. A computer system comprising:
a processor; and
a non-transitory computer-readable storage medium storing instructions that, when executed by the processor, perform actions comprising:
receiving, at an online system, a plurality of user reviews for a plurality of items included among one or more inventories of one or more retailers associated with the online system, wherein each user review of the plurality of user reviews is associated with an item of the plurality of items;
generating a review embedding for each user review for each item of the plurality of items based at least in part on a corresponding user review for a corresponding item;
receiving, from a client device associated with a user of the online system, a request for information describing a set of items; and
responsive to the received request:
identifying the set of items;
identifying contextual information associated with a current session of the user with the online system;
generating a user embedding for the user based at least in part on user data associated with the user and the identified contextual information associated with the user;
comparing the user embedding to a set of review embeddings for each item of the set of items;
identifying a set of user reviews for each item of the set of items based at least in part on the comparing;
generating a prompt for a summarized review for each item of the set of items, wherein the prompt comprises the identified set of user reviews for each item of the set of items and a request to summarize, for the user, the identified set of user reviews for each item of the set of items;
providing the prompt to a large language model to obtain the summarized review for each item of the set of items; and
sending a user interface for display to the client device associated with the user, wherein the user interface comprises the set of items and the summarized review for each item of the set of items.
